(19) United States
(12) Patent Application Publication
(10) Pub. No.: US 2003/0050421 A1
(43) Pub. Date: Mar. 13, 2003

(54) Polymer composition and method of rapid preparation in situ

(76) Inventor: Carmen M. Salvino, Schaumburg, IL (US)

Correspondence Address: Michelle L. Evans, Suite 1500, 700 N. St. Mary 's Street, San Antonio, TX, 78205, US

(21) Appl. No.: 09/946,996

(22) Filed: Sep. 5, 2001

(51) Int. Cl. C08G 18/00

(52) U.S. Cl. 528/44

(57) ABSTRACT

A fluid composition which generates a partially gelled polymer matrix and a method for its preparation in situ. The reactants that form the novel fluid are held in separate vessels. When desired, the reactants are introduced into a mixing chamber for reaction to form the partially gelled novel fluid. The partially gelled novel fluid has the particular properties that hold fillers and additives for secondary reactions to occur in the same vessel. This composition and method of preparation have particular application to items that utilize a combination of reactive polymers, which include polyurethanes, epoxies, and polyesters, such as bowling balls, and other molded polymer parts such as those used in automotive, marine, sporting goods, appliances, and toys.

### BACKGROUND OF THE INVENTION

1. Field of The Invention

Applicant's invention relates to a polymer composition and method of using a novel fluid to create an almost instantaneous, nonreversible, predictable, adjustable, and substantial viscosity increase in a thermosetting polymeric resin admixture.

This thermosetting polymeric resin admixture will hereinafter be referred to as the “resin admixture” throughout the remainder of this document. The resin admixture components which are related to the generation of said rapid viscosity increase are the primary focus of the instant invention, and are hereinafter referred to as the “novel fluid” throughout the remainder of this document. The novel fluid is a subcomponent of the resin admixture which describes the complete mixture of ingredients used to manufacture the final molded parts. The novel fluid contains chemical components for the purpose of trapping particles of widely differing particle densities in said resin admixture and freezing said particles in place in the resin admixture, thereby preventing these particles from either sinking or floating. Subsequent to this rapid viscosity increase, the resin admixture can be cured in the normal fashion, yielding a useful filled polymer molded part. Because a very rapid and substantial viscosity build is accomplished in said resin admixture, and particles of widely varying densities are trapped in place, their movement through the resin admixture is prevented, resulting in the homogeneity of the resin admixture density being preserved, without any appreciable density gradients being formed in the resin admixture, or the resulting molded part.

2. Background Information

Conventional methods of making particle filled thermosetting resin molded parts typically experience difficulties with particles either sinking or floating in the resin admixture used to mold the desired parts. The tendency for particulate fillers to sink or float in the resin admixture used to mold such parts has the effect of destroying the homogeneity of the resin admixture, thereby causing unwanted density gradients in the final molded parts. The instant invention makes use of a novel rapid, suddenly induced change in the viscosity of the resin admixture, which allows for said resin admixture to be mixed, de-aerated, and pumped or poured into a mold easily, while in a low viscosity state, without entrapping excessive air bubbles in the said resin admixture. The aforementioned rapid increase in viscosity of the resin admixture can be timed to occur in the mold, after filing to fix low or high density particles in place without density gradients occurring in the molded part. The novel fluid and its method of preparation has particular application to molded parts of thermosetting resins that utilized a combination of reactive polymers including, but not limited to polyurethanes, epoxies, and unsaturated polyesters, and a combination of low and high density fillers, either miner, or man-made. Once the resin admixture has been transferred to the mold, and the density of the resin admixture has been fixed without density gradients, the resin admixture can be gelled and cured in the usual manner, thus producing a useful molded part. Prior to the instant invention, those skilled in the art used thixotropic agents such as fumed silica or certain clays to attempt to accomplish this task, but these agents were of limited utility because the amount of viscosity build was limited, and because special high shear mixing equipment was required to shear the thixotropic agents into the resin prior to addition of the fillers. This high shear mixing equipment has a tendency to damage fragile, hollow, spherical glass bubble fillers, making them useless. Further problems occurred due to the fact that the resin admixtures had to be kept constantly sheared to prevent the mix viscosity from starting to build before the resin admixture had been transferred to the mold and frequently air entrapment, or filler migration occurred because the thixotropic agent was no completely effective. The shear produced by this continual mixing also tends to damage low density hollow glass or plastic fillers, as well as generating unwanted heat in the resin admixture. IN some thermosetting resins, particularly polyurethanes and epoxies, said thermosetting resins get very hot, and actually undergo a substantial heat induced viscosity decrease before they gel. This heat induced viscosity decrease, prior to the gellation of the resin admixture, tends to exacerbate the tendency of the light or heavy particles to sink or float, thereby decreasing the ability of the molder to make molded parts without density gradients. The instant invention corrects these problems, because it allows the user to make use of an in-situ generate d thickening agent to control the timing, and extent of the thickening that occurs. In contrast to conventional methods which rely upon thixotropic agents, the user of the instant invention can change the amounts and types of reactants used to cause the thickening to occur, thereby giving him precise control over the time and degree of viscosity build that occurs. This measure of control over the timing and degree of viscosity build that occurs in the resin admixture is unavailable to the user of conventional thixotropic agents. The method described in the instant invention has been used by the inventor with considerable success in the manufacture of bowling balls, but should not be considered to be in any way limited to that pursuit. The instant invention can be used effectively for any process in which careful density gradient control of thermosetting molded parts is required.

### SUMMARY OF THE INVENTION

An object of the instant invention is to provide a resin admixture which has a gelled phase (produced by the novel fluid), and an ungelled phase evenly distributed together.

Another object of the instant invention is to provide a resin admixture which has a gelled phase and an ungelled phase evenly distributed together for the purpose of trapping, and holding in suspension, particulate filler material.

Another object of the instant invention is to provide a resin admixture which has the ability to trap, and hold in suspension, particulate matter of widely varying densities, said particulate matter being of higher density than the density of the resin admixture.

Another object of the instant invention is to provide a resin admixture which has the ability to trap, and hold in suspension, particulate matter of widely varying densities, said particulate matter being of a lower density than the density of the resin admixture.

Another object of the instant invention is to provide a resin admixture which has the ability to trap, and hold in suspension, particulate matter of widely varying densities, said particulate matter being of substantially higher density than the density of the resin admixture.

Another object of the instant invention is to provide a resin admixture which has the ability to trap, and hold in suspension, particulate matter of widely varying densities, said particulate matter being of substantially lower density than the density of the resin admixture.

Another object of the instant invention is to provide a resin admixture which has the ability to trap, and hold concurrently in suspension, various mixtures of particulate matter, said particulate matter being of substantially lower density and or of substantially higher density than the density of the resin admixture.

Another object of the instant invention is to provide for in-situ generation of the gelled phase of the above mentioned resin admixtures.

Another object of the instant invention is to provide for the ungelled phase of the above mentioned resin admixture to be composed of various thermosetting resins, which can be solidified into a rigid resinous mass for the purpose of casting a wide variety of useful objects, said objects containing evenly distributed particulate matter, or blends of particulate matter, which impart desirable characteristics to the molded part. The desirable characteristics imparted to such parts may include, but are not limited to: weight gain, or weight reduction, increased or decreased abrasion resistance and wear properties, increased strength or toughness, improved impact resistance, increased or decreased coefficient of friction, increased or decreased coefficient of restitution, increased or decreased oil absorption properties, increased or decreased dielectric properties, or combinations of the above cited properties.

Another object of the instant invention is to provide for the in-situ generation of the above mentioned resin admixture upon demand, at the point during the manufacture of the aforementioned molded parts, where the trapping in suspension of the particulate filler materials is desirable for the purpose of producing molded parts without density gradients caused by floating or sinking of low or high density filler materials in the resin admixture.

Another object of the instant invention is to provide for the formation of the aforementioned novel fluid by using the generation of a polyurea component in the novel fluid.

Another object of the instant invention is to provide for a method of generating the aforementioned novel fluid without limiting the amount of particulate filler which may be incorporated into the product.

Another object of the instant invention is to provide for a novel method of producing particulate filler reinforced molded parts, without density gradients, which eliminates equipment viscosity limitations.

Another object of the instant invention is to provide for a novel method of producing density gradient free particulate filler reinforced molded parts, without the need of relying upon conventional thixotropic materials to keep the light or heavy fillers from floating or sinking respectively. Conventional thixotropic agents have many problems which complicate the production of filled molded parts, including, but not limited to, requirements for high shear mixing equipment to shear the thixotropic agent into the casting resin, said high shear mixing equipment often causing damage or breakage of fragile hollow glass or plastic fillers due to the intensity of the shear of the mixing equipment. The use of conventional thixotropic agents often require higher mix viscosities during the pumping of the filled resin admixture. These higher mix viscosities often require higher pumping pressure than is required for the instant invention, and these higher pumping pressures often can cause collapse and breakage of fragile hollow glass or plastic lightweight fillers. Conventional thixotropic agents also generally exhibit poorer effectiveness of preventing density gradients because conventional thixotropic agents are generally far less effective in trapping and preventing particles from moving in the resin admixture than the method provided in the instant invention. This is because conventional thixotropic agents simply build viscosity, while the method of the instant invention gels, and freezes the particles in place.

Another object of the instant invention is to provide for the in-situ generation of the novel fluid at the time that the resin admixture is injected into the mold, or very shortly thereafter. This in-situ generation and timing allows for the resin admixture to be pumped into the mold at the lowest viscosity possible, then the fillers are rapidly fixed in place by the almost instantaneous gellation of the novel fluid phase of the instant invention. The remaining resinous component of the resin admixture can then be gelled and cured in a reasonable time frame, without having to over accelerate the gel and cure the rate of the resin admixture. Avoiding the over acceleration of the resin admixture gel and cure rate avoids such problems as burning and cracking which often occur when resin admixture gel and cure rates are accelerated beyond their normal limits.

Another object of the instant invention is to provide for the preparation of the novel fluid in the same mixing vessels as the resin admixture. Using the same mixing vessel as the polymer admixture itself guarantees that the novel fluid will be introduced in exactly the proper ratio to the resin admixture, and this also simplifies the equipment design since conventional two stream pouring equipment may be used without modification. This obviates the need for a four stream, i.e. four vessels and four pumps, system which would be much more complicated as well as much more costly to purchase, set up, and run than a conventional two stream system.

Another object of the instant invention is to provide for the incorporation of the aforementioned novel fluid into a polymeric resin admixture to maintain homogeneity of additives incorporated during the preparation of a molded item.

Another object of the instant invention is to provide a method of producing a molded polymer part at a lower overall viscosity than is possible with conventional thixotropic mixtures. This lower mix viscosity has the advantage of producing a molded polymer part with less entrapped air than is possible with conventional means. This reduction of entrapped air further improves the density homogeneity of the finished part, as well as provides cosmetic benefits such as reduced porosity in the parts surface.

Another object of the instant invention is to provide a novel bowling ball formed by the process that incorporates the novel fluid described in the instant invention.

In satisfaction of these and related objectives, applicant's instant invention provides for a novel fluid and method for its preparation in-situ. Applicant's invention permits its practitioner to incorporate this novel fluid, its process, or both into items such as molded polymer parts, and specifically, but not limited to bowling balls, such molded parts which use singularly, or in combination, such thermosetting reactive polymers which include polyurethanes, epoxies, polyesters, etc. The incorporation of the novel fluid described in applicant's instant invention maintains the uniformity of fillers and additives incorporated during the preparation of the molded polymer part. The instant invention also allows dramatic slowing of the gel and cure rate of the resin polymer used in the production of the molded par, which subsequently produces a finished molded par which is much less likely to have defects such as burning or cracking. Said burning and cracking that is eliminated by the instant invention is generally caused by an over accelerated gel and cure rate. The instant invention also allows for significant improvements in the surface quality of the finished molded part, by reducing porosity caused by air entrapment.

### BRIEF DESCRIPTION OF THE DRAWINGS

FIG. 1 is a perspective view of the preferred embodiment method of the instant invention.

### DETAILED DESCRIPTION OF THE PREFERRED EMBODIMENT

The instant invention relates to a novel fluid and a method for its preparation in-situ. More particularly, the instant invention relates to an in-situ generated gel matrix, which traps and holds particulate fillers in place, and the method of its preparation. This composition and method can be incorporated into various polymers that are used to make molded parts, including, but not limited to bowling balls.

The technology present in the instant invention is predicated on the relative kinetics of competing chemical reactions, and the excess amount of certain of those chemicals to limit molecular weight development of some products while at the same time providing a chemical supply for subsequent secondary reactions. Further, the instant invention demands that reactive components be separated until final disposition. The instant invention presumes that inert fillers can be maintained uniformly dispersed in a fluid by continuous mixing or recirculation techniques commonly used and commercially available to those practiced in the art.

The novel fluid of the instant invention incorporates preferably a polyurea, although other very rapidly gelling polymers could be used. Polyurea, —[RNHCONHR]—is a product of the reaction between an isocyanate, OCN-R and a companion reactant such as amine RNH2, carboxylic acid, RCOOH, or water H2O. In the presence of an excess amount of either isocyanate or the companion reactant, the polyurea formed is of low molecular weight and is essentially a dimer. In the presence of approximately equal or non-limiting amounts of either isocyanate or the companion reactant, the polyurea formed will be of higher molecular weight and will impart higher viscosity to the mixture. It is preferred that the polyurea of the instant invention be of low molecular weight, on the order of 200 g/mole to 2000 g/mole. The reactants in the preferred embodiment are difunctional or polyfunctional, and can be aliphatic, aromatic, branched, unbranched, or cycloaliphatic. Amines with which favorable results have been obtained in accordance with the invention include aliphatic amines such as n-aminoethylpiperazine (AEP), diethylenetriamine (DETA), and triethylenetetramine (TETA). In addition, isocyanates that have shown favorable results include aromatic poly (MDI) isocyanates such as polymethylene polyphenyisocyanate and aliphatic isocyanates such as hexamethylene diisocyanate. Some carboxylic acids that have shown beneficial results include carboxylic acid terminated polyesters. As to each group, alternatively mixtures of one or more of the select compounds can be used.

The present reaction forming a polyurea is notably faster (from 100 to 1000 times faster) than other reactions with an isocyanate, such as with primary alcohol, ROH, and is notably faster than other reactions with an amine, such as with epoxide, thus there is no reasonable likelihood of competitive reactions consuming one of the essential reactants. Furthermore, there is no reaction between an isocyanate and an epoxide, or between an amine and a hydroxyl containing compound, facts that allow for convenient separation of the reactants until polymerization is desired. This process for forming polyurea is accomplished in-situ which allows formation of the polyurea at the time of application or molding. At this stage, the polyurea is available to be eventually incorporated into the backbone of the polymer matrix.

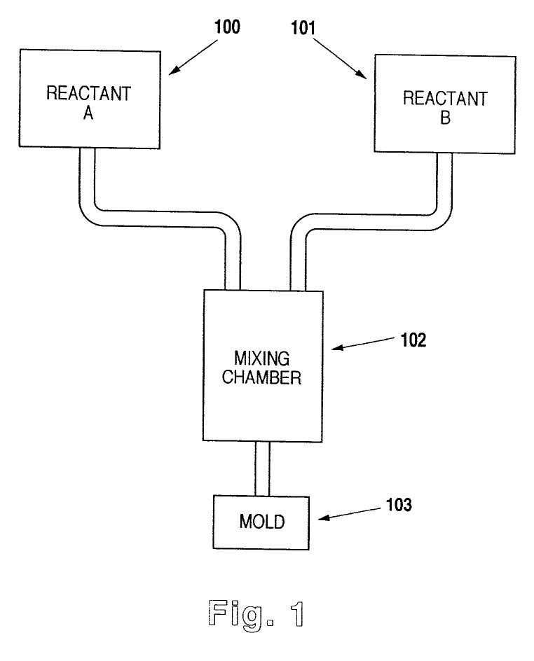

FIG. 1 illustrates the mode of preparation of the in-situ novel fluid. In order for the reaction to be accomplished in-situ, the reactants that form the novel fluid are held in separate vessels 100 and 101 until the novel fluid is needed. In the preferred embodiment, vessel 100 contains between 55% to 65% isocyanate, and vessel 101 contains between 35% to 45% amine, the balance of the material in the vessels being the remaining components of the resin admixture. When desired, the reactants are introduced into mixing chamber 102 whereby the reactants are mixed by impingement, and the reactants rapidly react, generally within 1 to 30 seconds, forming the novel fluid, said novel fluid which consists of a gelled matrix of polyurea with a molecular weight in the range of 200-300 g/mole. This novel fluid imparts an immediate and significant viscosity build to the resin admixture in the mold, which traps the particulate fillers in the resin admixture, holding them in place and preventing any density gradients caused by filler sinking or float out. Since the particulate fillers are effectively trapped by the polyurea matrix, there is no hurry for the remainder of the resin admixture to gel and cure, and no reason to over accelerate the gel and cure cycle of the resin admixture. This remaining resin admixture can be gelled and cured at a slower pace, which gives far superior part quality, and fewer surface defects.

This in-situ preparation of the novel fluid is particularly useful in methods of preparing items that incorporate epoxies, unsaturated polyesters, polyurethanes, and various other thermosetting plastics. Polyurethanes contain urethane groups in their backbone. They are obtained by the reaction of a diisocyanate or polyisocyanate with a macroglycol (polyol), or with a combination of a polyol and short chain glycol extender. The polyols are based on polyethers, polyesters, or a combination of both. Unsaturated polyesters are macromolecules with polyester backbones derived from the interaction of unsaturated dicarboxylic or polycarboxylic acids or anhydrides and polyhydric alcohols. Epoxies are monomers or pre-polymers that further react with curing agents to yield high performance thermosetting plastics. Epoxy resins are characterized by the presence of a three membered cyclic ether group.

In the preparation of such polymers that incorporate the composition and/or the method of the instant invention, the reactants that form the novel fluid will be placed in separate vessels 100 and 101 until the novel fluid is needed. In addition, between 45% (vol) to 65% (vol) of the liquid reactants of the resin admixture are placed into vessel 100. The remainder of the liquid reactants are placed in vessel 101. A particulate filler may be added to either vessel. These particulate fillers may be of a density from 0.009 g/ml to 11.3 g/ml, and may comprise from 0.2% (vol) to 30.0% (vol) of the total composition. The contents of both vessels 100 and 101 are then mixed in an impingement mixing chamber 102, which results in both a primary and secondary reaction. The primary reaction occurs rapidly between the reactants that form the novel fluid, which in the preferred embodiment is polyurea. The primary reaction occurs on the order of 1 to 30 seconds. This allows the polyurea to be formed at the time of the application or molding, specifically just after the mold is filled. At this point, the novel fluid is gelled, but is still able to be incorporated into the backbone of the polymer matrix. In the secondary reaction, polymerization occurs with the thermosetting resin admixture. With the appropriate selection of reactants and properties, the novel fluid can hold the particulate filler mix in suspension while the secondary reaction proceeds. Upon completion of the secondary reaction, the novel fluid and any particulate filler contained therein are evenly dispersed throughout the cured polymer.

The formation of the novel fluid in the preferred embodiment of the instant invention is accomplished entirely in-situ at the time of the final mixing and disposition in a mold 103 or on a substrate. The preferred manner of this final mixing is with an impingement mixer, but in cases where low density, hollow glass or plastic fillers are being used, some of these fillers cannot withstand the shear generated by the impingement mixer without breakage. In these cases a motorized mechanical mixing chamber may be used in place of the impingement mixer. In cases where very low density hollow glass or plastic fillers are being used, and impingement or motorized mixing chambers would fracture or collapse the hollow spheres, a simple static mixing tube may be used to get a good effect. The main advantage to the impingement mixer is its low contained volume, a faster reacting novel fluid may be used. For the mechanical mixer and the static mixing tube methods, one must use a slower reacting novel fluid to prevent gelling of the material in the mixing device. Frequent flushing of mix heads may also be incorporated, but this may require excessive solvent use and results in higher material costs.

Until the final mixing phase of the process, the reactive components are held in separate vessels 100 and 101. In the case of an epoxy, vessel 100 will contain between 50% (vol) to 68% (vol) of epoxy resin, 0.4% (vol) to 5.0% (vol) of isocyanate, and 0.2%(vol) to 30%(vol) of a particulate filler, and vessel 101 will contain 8% (vol) to 14% (vol) of amine, and 10%(vol) to 40%(vol) of nonreactive diluent or plasticizer if required to attain certain physical properties, or to help balance the volume ratios between the two tanks. The preferred embodiment uses a ratio of isocyanate to amine of between 1:10 to 1:40. When the contents of both vessel 100 and vessel 101 are mixed a polyurea of low molecular weight on the order of 200 g/mole to 2000 g/mole is formed virtually immediately. This polyurea gel matrix will hold the filler in suspension during the interval required for the secondary reaction of the epoxy to proceed to completion. Polyurethanes, unsaturated polyesters, and other thermosets may be substituted for the epoxy in this reaction. The resulting modified polymer that is formed contains by volume preferably 1% (vol) to 3%(vol) polyurea, 55% (vol) to 75%(vol) thermosetting polymer, 0.2% (vol) to 30% (vol) particulate filler, and 0% (vol) to 40%(vol) inert diluents or plasticizers depending upon the desired properties of the final polymer.

The following examples are intended to illustrate some typical resin admixtures which make use of the instant invention.

TABLE 1

| | |
|---|---|
| Vessel 100 | Vessel 101 |

| Ingredient | % (wt) | Ingredient | % (wt) |
|---|---|---|---|
| Epon 828 Epoxy | 53.0 | Mica | 3.8 |
| Isocyanate | 1.2 | TXIB Plasticizer | 32.0 |
| | | Aminoethylpiperazine | 10.0 |

TABLE 2

| | |
|---|---|
| Vessel 100 | Vessel 101 |

| Ingredient | % (wt) | Ingredient | % (wt) |
|---|---|---|---|
| Epon 828 Epoxy | 56.0 | 3000 Solid Glass | 3.8 |
| Isocyanate | 1.2 | Spheres | |
| | | 2088 Benzoate | 27.5 |
| | | Aminoethylpiperazine | 11.5 |

TABLE 3

| | |
|---|---|
| Vessel 100 | Vessel 101 |

| Ingredient | % (wt) | Ingredient | % (wt) |
|---|---|---|---|
| Epon 828 Epoxy | 56.0 | Q-300 Hollow | 4.0 |
| Isocyanate | 1.2 | Spheres | |
| | | TXIB Plasticizer | 27.3 |
| | | Aminoethylpiperazine | 11.5 |

TABLE 4

| | |
|---|---|
| Vessel 100 | Vessel 101 |

| Ingredient | % (wt) | Ingredient | % (wt) |
|---|---|---|---|
| Epon 828 Epoxy | 53.0 | Pumice | 3.0 |
| Isocyanate | 1.5 | TXIB Plasticizer | 33.5 |
| | | Aminoethylpiperazine | 9.0 |

TABLE 5

| | |
|---|---|
| Vessel 100 | Vessel 101 |

| Ingredient | % (wt) | Ingredient | % (wt) |
|---|---|---|---|
| Epon 828 Epoxy | 58.0 | Q-300 Hollow | 4.0 |
| Isocyanate | 1.2 | Spheres | |
| | | Rubber | 1.0 |
| | | TXIB Plasticizer | 25.8 |
| | | Aminoethylpiperazine | 10.0 |

TABLE 6

| | |
|---|---|
| Vessel 100 | Vessel 101 |

| Ingredient | % (wt) | Ingredient | % (wt) |
|---|---|---|---|
| Epon 828 Epoxy | 58.0 | 6014 Hollow Spheres | 1.2 |
| Isocyanate | 1.2 | Rubber | 9.0 |
| | | TXIB Plasticizer | 20.6 |
| | | Aminoethylpiperazine | 10.0 |

TABLE 7

| | |
|---|---|
| Vessel 100 | Vessel 101 |

| Ingredient | % (wt) | Ingredient | % (wt) |
|---|---|---|---|
| Epon 828 Epoxy | 59.0 | Rubber | 9.0 |
| Isocyanate | 1.9 | TXIB Plasticizer | 18.3 |
| | | Aminoethylpiperazine | 11.8 |

TABLE 8

| | |
|---|---|
| Vessel 100 | Vessel 101 |

| Ingredient | % (wt) | Ingredient | % (wt) |
|---|---|---|---|
| Epon 828 Epoxy | 55.0 | TXIB Plasticizer | 33.9 |
| Isocyanate | 2.1 | Aminoethylpiperazine | 9.0 |

TABLE 9

| | |
|---|---|
| Vessel 100 | Vessel 101 |

| Ingredient | % (wt) | Ingredient | % (wt) |
|---|---|---|---|
| Epon 828 Epoxy | 57.0 | PM-6545 Spheres | 0.29 |
| Isocyanate | 1.7 | Rubber | 9.00 |
| | | TXIB Plasticizer | 20.51 |
| | | Aminoethylpiperazine | 11.5 |

For the preferred embodiment of the instant invention, the isocyanate used should be of low molecular weight and low viscosity. An equivalent weight of 100-140 g/mole is preferred. The viscosity of the isocyanate should be below 200 cps @ 25° C. It is necessary that the isocyanate of choice be compatible with and/or soluble in the epoxy resin or other polymeric resin used. For the preferred embodiment one should choose a Bisphenol-A epoxy resin. The isocyanate is most effective when it is used in the range of between 0.1% (wt) to 2.0% (wt) in the example formulations. Too little viscosity build is developed below this range and too much viscosity build is developed if the isocyanate percentage is above the desired range. The instant invention is also capable of increasing the coefficient of friction of the molded part if the isocyanate percentage is at the higher end of the stated range.

The instant invention is also useful in achieving in-situ substantial viscosity build in the novel fluid and is able to trap particulate fillers and retard movement of said fillers through the resin admixture over a broad range of filler densities. The author reports success over the range of as low as 0.009 g/ml for thermoplastic microballoons to as high as 11.3 for lead powder. Other useful inert fillers claimed to enhance the density and other specific properties such as frictional properties, coefficient of restitution, fire resistance, abrasion resistance, etc. of the molded part include, but are not limited to: microspheres and microcellular products made from thermosetting or thermoplastic resins, hollow or solid glass spheres, sand and a wide range of mineral fillers of various densities, such as calcium carbonate, barite, iron oxide, lead powder, ground glass, mica, pumice, talc, and diatomaceous earth, etc. Iron, iron oxide, or carbon fillers can be used to modify the dielectric or magnetic properties of the molded part.

Various plasticizers may be added to modify the physical properties of elasticity, hardness, and flexibility etc of the molded part. These plasticizers may be incorporated at levels of between 0% (vol) to 40% (vol), depending upon the type of polymer used in the resin admixture, and the specific properties the user wishes to achieve in the finished molded part. When the method of the instant invention is applied to the manufacture of bowling balls, a preferred plasticizer is Velsicol Benzoflex 2088, a blend of benzoate esters.

The instant invention can be used in the manufacture of various polymeric molded parts. The instant invention can be applied especially well to the manufacture of bowling balls, and particularly for the use in the manufacture of bowling balls that incorporate various particulate fillers and plasticizers to enhance bowling ball performance. It will be understood by those skilled in the art that know types of bowling ball manufacturing equipment can be used in the manufacture of bowling balls by the method described in the instant invention, and neither additional new equipment nor modifications to existing equipment is required in most cases in order to make use of the instant invention.

Bowling balls containing an inner core and an outer core are known in the prior art. In addition, it will also be understood by those skilled in the art that the instant invention can be applied to any typical bowling ball utilizing conventional materials. Such conventional shell materials may include, but are not limited to unsaturated polyesters, polyurethanes, and epoxies of various types. One or more inner cores or outer shells of the same or varying composition may be used within the bowling ball and provided for in the manner shown below for a bowling ball having a single inner core and a single outer shell or layer. Both the inner core and the outer shell may be manufactured of such materials as are known in the art. The use of the instant invention can be applied in both the inner core and in the outer shell as is needed to restrict the movement of particulate matter through the core or shell and thus prevent undesirable density gradients from being formed.

Although the instant invention has been described with reference to specific embodiments, and specifically to bowling balls in this description, it is to be construed that the instant invention is a very general and widely useful invention and is applicable to many other embodiments and products other than bowling balls. This description is not considered to be limited or construed in a limited sense, but is a very general process which may be useful for a wide range of embodiments requiring density gradient control of polymeric resin admixtures containing a wide variety of particulate fillers. Various inventions will become apparent to those skilled in the art upon the reference to the description of the instant invention. It is therefore contemplated that the appended claims will cover such modifications that fall within the scope of this invention.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A polymeric composition comprising a first part and a second part, said first and second parts when homogeneously admixed together generate a novel fluid which has the ability to form almost instantaneously a gelled resin matrix.

2. The composition of claim 1 wherein said formation of said gelled resin matrix occurs in a time frame of between 0.1 seconds and 30 seconds.

3. The composition of claim 2 wherein the reaction speed which regulates the speed of formation of the gelled resin matrix can be adjusted to suit the requirements of the manufacturing process being used for production of a molded polymeric resin part.

4. The composition of claim 3 wherein said first and said second parts are homogeneously mixed as minor components into the two component streams of a two stream polymeric resin admixture to form a resinous polymeric admixture, said resinous polymeric admixture being useful for manufacturing molded polymeric resin parts.

5. The composition of claim 4 wherein said first and second parts when homogeneously admixed together will generate, almost instantaneously, a gelled resin matrix, said gelled resin matrix being homogeneously mixed with the other components of said polymeric resin admixture, the other components of said polymeric resin admixture remaining in a liquid and ungelled state for a short period of time.

6. The composition of claim 5 wherein within said polymeric resin admixture said novel fluid is in the gelled solid state, while the remaining components of the polymeric resin admixture remain in the liquid phase for a period of time.

7. The composition of claim 6 wherein the liquid components of the polymeric resin admixture remain in the liquid phase from 1 minute to 30 minutes.

8. The composition of claim 1 wherein said first part is isocyanate and said second part is amine.

9. The composition of claim 1 wherein the gelled resin matrix is composed of a polyurea.

10. The composition of claim 1 wherein said isocyanate is a diisocyanate, a polyisocyanate, or a blend of a diisocyanate and a polyisocyanate.

11. The composition of claim 1 wherein said amine is a diamine, polyamine, or a blend of a diamine and a polyamine.

12. The composition of claim 1 wherein said gelled resin matrix is generated in-situ.

13. The composition of claim 4 wherein said polymeric resin admixture is a filled admixture filled with a particulate filler.

14. The composition of claim 13 wherein said polymeric resin admixture comprises a filling with a blend of particulate fillers.

15. The composition of claim 13, wherein said filler is a low density filler, of a density less than the average density of the liquid components of the polymeric resin admixture.

16. The composition of claim 15 wherein said low density filler is a hollow spherical natural or man made filler.

17. The composition of claim 16 wherein said filler is selected from the group consisting of Q Cells, Extendospheres, and 3M Glass Bubbles.

18. The composition of claim 13 wherein said filler is a high density filler of a density greater than the average density of the liquid components of the polymeric resin admixture.

19. The composition of claim 15 wherein said high density filler is a finely ground natural mineral or man made filler.

20. The composition of claim 19 wherein said filler is selected from the group consisting of calcium carbonate, barite, hematite, zinc powder, or lead powder.

21. The composition of claim 13 wherein said polymeric resin admixture is filled with at least one low density or high density filler, said filler being in the range of densities from 0.009 g/ml to 11.3 g/ml.

22. The composition of claim 21 wherein at least one filler comprise 0.2% (vol) to 30% (vol) of the filled polymeric resin admixture.

23. The composition of claim 4 wherein said polymeric resin admixture comprises a plasticizer for modifying the physical properties of the finished molded part.

24. The composition of claim 4, wherein said polymeric resin admixture comprises a polymeric precursor comprising a polyol that reacts with an isocyanate to form a polyurethane polymer.

25. The composition of claim 4 wherein said polymeric resin admixture comprises a polymeric precursor comprising an epoxy precursor that reacts with an amine hardener.

26. A method for the preparation of an in-situ generated low molecular weight polyurea sequentially with a polymerization reaction in the same reaction vessel to form a polymer, said polymer incorporating said polyurea into its backbone to form a novel fluid comprising the steps of:
introducing an isocyanate and at least one polymer precursor into the first vessel, said isocyanate being a precursor to said polyurea;
introducing a super excess of an amine, relative to said isocyanate into the second vessel, said amine being a precursor to said polyurea and said second vessel being in proximity to said first vessel;
introducing said isocyanate, said polymer precursor and said amine into a mixing chamber, said isocyanate and same amine rapidly reacting to form said polyurea and said polymer precursor polymerizing to form said polymer, whereby said polyurea is incorporated into the backbone of said polymer to form said partially gelled polymeric resin composition comprising 1% (vol) to 3% (vol) polyurea and 55% (vol) to 75% (vol) polymer, the remaining portion of the molded part comprised of particulate fillers and/or nonreactive diluents or plasticizers.

27. The method of claim 26 further comprising the step of introducing a filler into said first vessel, whereby once said polyurea is formed said polyurea holds said filler in suspension until said polymerization of said polymer precursor occurs.

28. The method of claim 27 further comprising the step of introducing a plasticizer into said second vessel.

29. The partially gelled polymeric composition formed by the process of claim 26.

30. A product manufactured with the novel fluid of claim 1.

31. A bowling ball manufactured with the novel fluid of claim 1.
